(19) United States
(12) Patent Application Publication
(10) Pub. No.: US 2026/0160544 A1
(43) Pub. Date: Jun. 11, 2026

(54) Determining Tip Size in a Phacoemulsification Probe

(71) Applicant: JOHNSON & JOHNSON SURGICAL VISION, INC., Irvine, CA (US)

(72) Inventors: Vadim Gliner, Haifa (IL); Assaf Govari, Haifa (IL); Andres Claudio Altmann, Haifa (IL); Alon Boumendil, Haifa (IL); Omry Kadosh, Haifa (IL)

(21) Appl. No.: 18/975,674

(22) Filed: Dec. 10, 2024

Related U.S. Application Data
(60) Provisional application No. 63/728,609, filed on Dec. 5, 2024.

(51) Int. Cl. G01B 13/10

(52) U.S. Cl. CPC G01B 13/10

(57) ABSTRACT

Apparatus for determining a needle size including a phacoemulsification probe having a distal tip. The probe has an aspiration channel that transfers aspiration fluid from the distal tip and that has a first pressure sensor coupled with the channel, and an irrigation channel that transfers irrigation fluid to the distal tip and that has a second pressure sensor coupled with the channel. A needle-sleeve combination, consisting of a sleeve coaxially surrounding the needle, is coupled with the probe distal tip. A processor acquires from the first pressure sensor a first pressure profile of the aspiration fluid passing the first pressure sensor and acquires from the second pressure sensor a second pressure profile of the irrigation fluid passing the second pressure sensor. The processor formulates a difference between the two profiles, and determines the size of the needle of the needle-sleeve combination in response to the difference.

### CROSS-REFERENCE TO RELATED APPLICATIONS

This application claims priority to U.S. Provisional Application Ser. No. 63/728,609, filed Dec. 5, 2024. The entire content of the aforementioned application is incorporated herein by reference in its entirety.

### FIELD OF THE DISCLOSURE

This disclosure relates generally to phacoemulsification, and specifically to operation of a phacoemulsification probe.

### BACKGROUND

In cataract surgery, phacoemulsification may be used to emulsify an eye's natural lens, and the emulsified matter may then be aspirated from the eye. An ultrasonic handpiece may be used to perform the emulsification, and the handpiece may also be configured to perform the aspiration. To maintain the intraocular pressure of the eye at a satisfactory level, the eye is irrigated during the aspiration.

### BRIEF DESCRIPTION OF THE DRAWINGS

The present disclosure will be understood from the following detailed description, taken in conjunction with the drawings in which:

FIG. 1A is a pictorial view of a phacoemulsification apparatus, according to an example of the present disclosure;

FIG. 1B is a schematic view of part of the apparatus, according to an example of the present disclosure;

FIG. 2 is a block diagram of elements of the apparatus, according to an example of the present disclosure;

FIG. 3A is a flowchart of steps for generating a calibration for a needle of a needle-sleeve combination, according to an example of the present disclosure;

FIG. 3B is a flowchart of steps for finding the diameter of the needle of the needle-sleeve combination, according to an example of the present disclosure;

FIG. 4 shows schematic graphs illustrating some of the steps of the flowcharts of FIG. 3A and FIG. 3B, according to an example of the present disclosure;

FIG. 5 shows schematic graphs of pressure vs. time for irrigation pressure sensors, according to an example of the present disclosure; and

FIG. 6 is a flowchart of steps for finding a sleeve diameter of the sleeve of a needle-sleeve combination being used in a procedure, according to an example of the present disclosure.

### DESCRIPTION OF EXAMPLES

### Overview

A phacoemulsification procedure on the eye of a patient, to remove the natural lens of the eye, may be carried out using a phacoemulsification handpiece. The handpiece is connected to a detachable, user-selectable, needle-sleeve combination, which comprises a hollow needle surrounded by a coaxial sleeve. During the procedure the needle is vibrated ultrasonically, and a distal end of the combination is placed within the capsular bag of the eye. The vibrations of the distal tip of the needle break the lens into smaller pieces which are then aspirated from the eye through the hollow needle.

There are a number of needle-sleeve combinations available to the physician performing the procedure, each combination having a different needle diameter, such as 19 gauge, 20 gauge, 21 gauge, or other diameters, as well as different sleeve diameters. The physician may select the combination considered to be appropriate for the procedure being performed.

The handpiece has an aspiration channel, and a proximal end of the channel is coupled with an aspiration pump via aspiration tubing. A distal end of the channel is coupled with the hollow needle of the combination. During the procedure the pump aspirates the emulsified material via the hollow needle and aspiration channel.

In addition to the aspiration provided by the pump, during the procedure the eye is separately irrigated using an irrigation pump, a gravity fed bottle, or pressurized infusion (collectively, “irrigation fluid source”). The handpiece has an irrigation channel, a proximal end of which is coupled with the irrigation fluid source via irrigation tubing. The distal end of the channel is coupled with the sleeve surrounding the hollow needle. During the procedure the irrigation fluid source transfers irrigation fluid, typically a balanced salt solution, via the irrigation tubing, the irrigation channel, and the sleeve to the eye.

The aspiration flow rate and the irrigation flow rate both affect the intraocular pressure (IOP) of the eye, so that to keep the IOP within required limits to prevent damaging structures of the eye it is necessary to measure and adjust both the aspiration flow and the irrigation flow at the eye. While the flow rates may be measured directly at the irrigation fluid source, there is a time delay to the handpiece. To overcome the delay, a handpiece processor may measure the rates indirectly by measuring the pressure with respective sensors in the aspiration channel and in the irrigation channel, and converting the measured pressures to flow rates using a calibration performed prior to the procedure.

The calibration applies for a given needle-sleeve combination attached to the handpiece, since the viscous forces on the aspirating and irrigation fluids are significantly different for each combination because of the differing combination dimensions. A physician using the handpiece may provide the processor with data, such as a needle gauge or an identification of the combination, enabling the processor to apply the correct calibration. However, in some cases no data is provided, or the data may be incorrect, or the physician may change the combination during a procedure. The processor may then be using an incorrect calibration.

In examples of the present disclosure the processor uses an independent method, i.e., one that does not require physician input, for determining the diameter of the needle in the needle-sleeve combination attached to the handpiece, so that the processor may apply the correct calibration. The method uses the fact that the pressures registered by the aspiration and irrigation pressure sensors, in response to a relatively abrupt change of flow rate in the aspiration channel, change gradually because of the narrow dimensions of the needle and the sleeve. Quantitatively the processor uses the sensors in the handpiece to measure the rate of change of the aspiration pressure and of the irrigation pressure when the aspiration flow rate changes abruptly.

The inventors have found that the difference between the aspiration pressure rate change and the irrigation pressure rate change depends on the diameter of the needle of the needle-sleeve combination attached to the handpiece. Examples of the disclosure use this property to generate, prior to a procedure, a correlation between rate differences and needle diameters, using needle-sleeve combinations with needles having known diameters. During the procedure the processor measures the difference in rates, and uses the correlation to determine the diameter of the needle in the combination being used for the procedure.

The relatively abrupt change of aspiration flow rate may be generated during priming of the handpiece, prior to performing the procedure. Alternatively, or additionally, the relatively abrupt change of flow rate may be generated during the procedure, for example on activation of an anti-vacuum surge (AVS) device.

The irrigation channel comprises two pressure sensors, either one of which may be used in the procedure described above for determining the needle diameter. In examples of the present disclosure the processor also uses the signals from both irrigation channel sensors to determine the diameter of the sleeve in the needle-sleeve combination.

The two irrigation channel sensors respond differently to an abrupt change of flow rate in the channel. The abrupt change may be initiated at the eye, for example by the physician manipulating a tool in the eye, or at the irrigation fluid source, for example by an irrigation pump changing the flow rate. The processor measures characteristics for each of the two responses, and from the differences of the characteristics determines the source of the abrupt change. When the abrupt change source is at the eye, the processor compares the differences of the characteristics with a calibration performed before the procedure, and from the calibration determines the diameter of the sleeve.

### System Description

In the following description, like elements are identified by the same numeral, and are differentiated, where required, by having a letter attached as a suffix to the numeral.

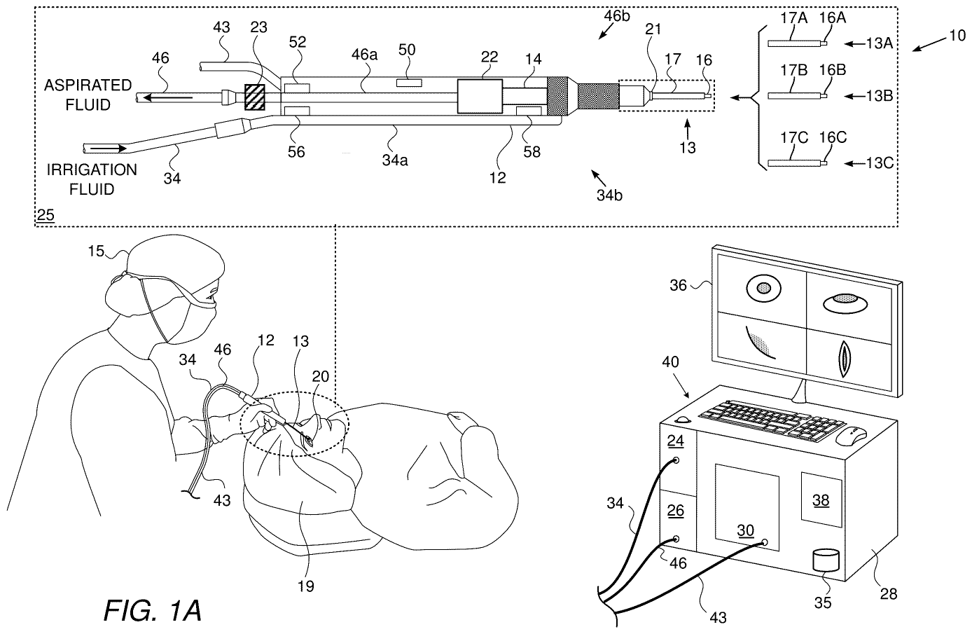

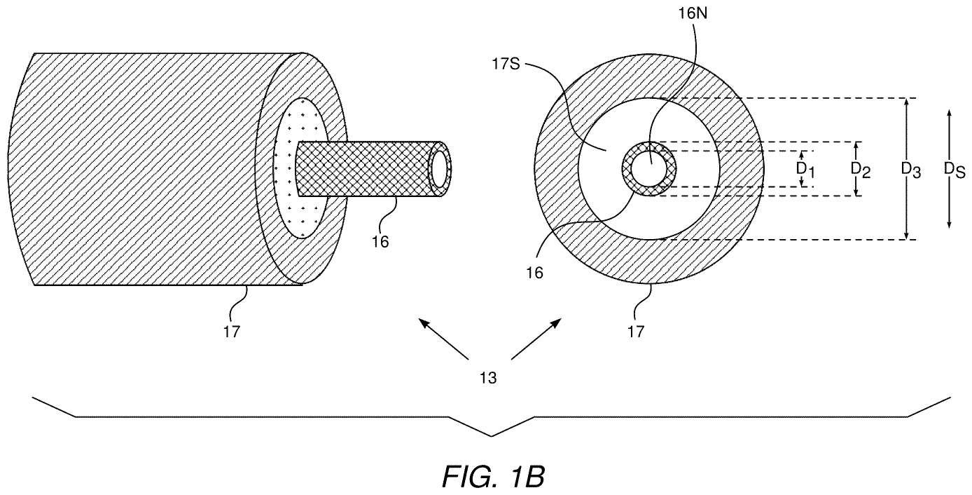

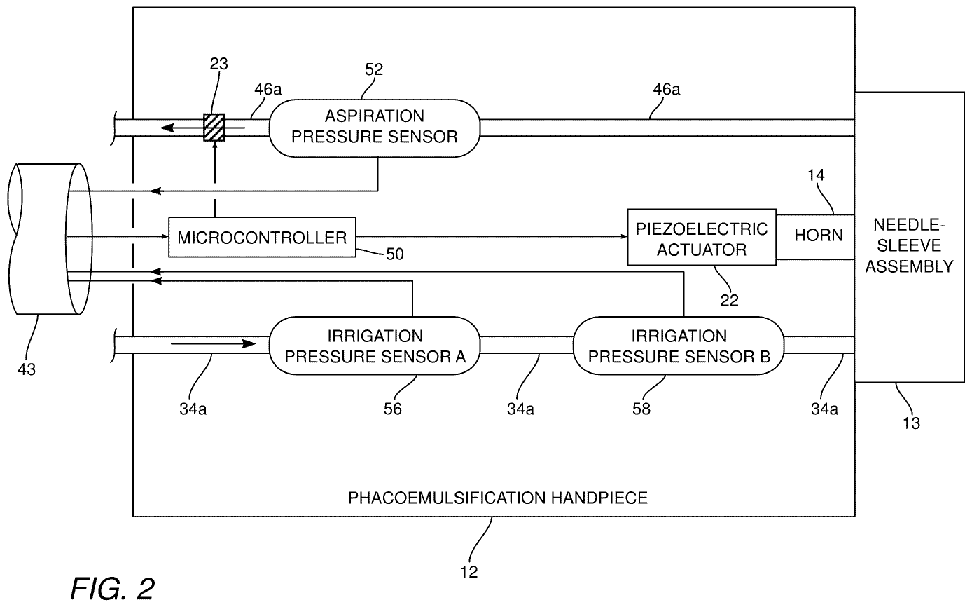

FIG. 1A is a pictorial view of a phacoemulsification apparatus 10 used in a phacoemulsification procedure, FIG. 1B is a schematic view of part of apparatus 10, and FIG. 2 is a block diagram of elements of the apparatus, according to an example of the present disclosure.

FIG. 1A includes an inset 25, and as shown in the figure and the inset apparatus 10 includes a phacoemulsification probe/handpiece 12 coupled with one of a multiplicity of detachable needle-sleeve combinations. FIG. 1 illustrates three combinations 13A, 13B, 13C, . . . , but in examples of the disclosure the multiplicity may be more or fewer than three. Each combination 13A, 13B, and 13C, respectively comprises a hollow needle 16A, 16B, and 16C, and a coaxial irrigation sleeve 17A, 17B, and 17C, and the dimensions of the needles and sleeves of the combinations are different. The irrigation sleeves at least partially surround their respective needles, and create a fluid pathway between the external wall of the needle and the internal wall of the sleeve.

Except where otherwise indicated, in the following description combinations 13A, 13B, and 13C, needles 16A, 16B, and 16C, and sleeves 17A, 17B, and 17C are generically referred to as combination 13, needle 16, and sleeve 17. As is illustrated in the figure, in the phacoemulsification procedure one of combinations 13 is coupled with a distal end 21 of handpiece 12.

FIG. 1B provides a schematic perspective view of combination 13, as well as a view of the combination along its central axis of symmetry. As is illustrated, needle 16 of the combination has an internal, generally cylindrical, lumen 16N having an inner diameter D₁. (The needle has an external diameter D₂.)

As is described below, a processor 38 measures flow rates of aspiration matter flowing through the internal lumen 16N by measuring pressures in an aspiration channel coupled with the lumen and converting the pressure to an aspiration flow rate using the diameter of the lumen. Thus, unless otherwise stated, in the present disclosure, a reference to the needle diameter is assumed to be understood as referring to needle inner diameter D₁.

Needle 16 is at least partially surrounded by sleeve 17, which has an inner diameter D₃. The sleeve and needle define a lumen having a generally annular cross-section 17S with an inner diameter D₂ and an external diameter D₃. As is described below, the lumen, herein also termed an annular lumen, is coupled with an irrigation channel wherein irrigation fluid flows. Processor 38 measures pressures of the fluid flowing in the irrigation channel and converts the pressures to an irrigation flow rate using an effective sleeve diameter D_{S} of the annular lumen. As is illustrated in FIG. 1B D₂<D_{S}<D₃.

The effective sleeve diameter D_{S} is the diameter of a circular lumen having substantially the same cross-sectional area as annular cross-section 17S, so that the annular lumen corresponds to a cylindrical sleeve lumen having a diameter D_{S}. Thus, unless otherwise stated, in the present disclosure, a reference to the sleeve diameter is assumed to be understood as referring to effective sleeve diameter D_{S}.

Needle 16 is configured to be inserted into a lens of an eye 20 of a patient 19. When combination 13 is attached to handpiece 12, needle 16 of the combination is configured to couple with a horn 14 of probe 12, and is shown in inset 25 as a straight needle. However, any suitable needle may be used with the phacoemulsification probe 12, for example, a curved or bent tip needle that is commercially available from Johnson & Johnson Surgical Vision, Inc., Irvine, CA, USA.

A physician 15 holds handpiece 12 so as to perform a phacoemulsification procedure on the eye 20 of patient 19. The physician may activate the handpiece using a foot pedal (not shown in the figures). Handpiece 12 comprises a piezoelectric actuator 22, which is configured to vibrate horn 14 and needle 16 in one or more vibration modes of the combined horn and needle. During the phacoemulsification procedure the vibration of needle 16 is used to break up the natural lens into small pieces.

Elements of apparatus 10 are under overall control of a processor 38 in a console 28. Functions of processor 38 are described in more detail below, and at least some of the functions of processor 38 may be carried out by suitable software stored in a memory 35. The software may be downloaded to a device in electronic form, over a network, for example. Alternatively, or additionally, the software may be stored in tangible, non-transitory computer-readable storage media, such as optical, magnetic, or electronic memory. Some or all of the functions of processor 38 may be combined in a single physical component or, alternatively, implemented using multiple physical components. The physical components may comprise hard-wired or programmable devices, or a combination of the two.

Piezoelectric actuator 22 is powered by a driving module 30 in console 28. Module 30, under overall control of processor 38, is configured to provide the power to the piezoelectric actuator 22, via a microcontroller 50, which may be located in the handpiece 12 or any other suitable location. Power for microcontroller 50, as well as control signals for the microcontroller, is delivered to the microcontroller by a cable 43 from driving module 30.

During the phacoemulsification procedure, an irrigation pump 24, which may be in or outside console 28, pumps irrigation fluid through an irrigation channel 34a in handpiece 12 to irrigation sleeve 17 so as to irrigate the eye. The fluid is pumped via an irrigation tubing 34, running from the irrigation pump 24, that is coupled with irrigation channel 34a of the probe 12 and one or more ports located on the distal end of irrigation sleeve 17 (collectively, irrigation line 34b).

An aspiration pump 26, which also may be located in or outside console 28, aspirates aspiration fluid, comprising eye fluid and waste matter (e.g., emulsified parts of the lens), from the patient's eye 20 via needle 16, through an aspiration channel 46a in handpiece 12. Aspiration pump 26 is in fluid communication with aspiration channel 46a via aspiration tubing 46 (collectively, aspiration line 46b).

Irrigation pump 24 and aspiration pump 26 may be any pump known in the art (e.g., a peristaltic pump, venturi, or a progressive cavity pump), and are both under overall control of processor 38.

An aspiration pressure sensor 52 is coupled with aspiration channel 46a, in a proximal section of the aspiration channel, so as to couple with the fluid in the aspiration channel.

An irrigation pressure sensor 56, also herein termed irrigation pressure sensor A, is coupled with irrigation channel 34a, in a proximal section of the irrigation channel, so as to couple with the fluid in the irrigation channel. A second irrigation pressure sensor 58, also herein termed irrigation pressure sensor B, is also coupled with irrigation channel 34a, in a distal section of the irrigation channel, so as to couple with the fluid in the irrigation channel.

The signals generated by the aspiration and irrigation sensors, sensor 52, 56, and 58, are provided via cable 43, as illustrated in FIG. 1A and FIG. 2, to processor 38. As is described below, processor 38 uses the signals from aspiration sensor 52 and irrigation sensor 56 to, inter alia, determine the needle 16 coupled with the handpiece. Processor 38 may use the signals from irrigation sensor 58, which is close to the eye, to provide an indication of the TOP of the eye, and also, as explained below, together with the signals of irrigation sensor 56 to determine the sleeve 17 coupled with the handpiece.

During the procedure, needle 16 may be occluded by emulsified parts of the lens, as the aspiration fluid is aspirated. The occlusion may cause the vacuum produced by aspiration pump 26 to increase, i.e., the pressure in channel 46a to decrease. When the occlusion clears, the increased vacuum may feedback to the eye, causing post occlusion surge (POS) resulting in trauma to the structures of the eye.

To prevent such feedback, system 10 comprises an anti-vacuum surge (AVS) device 23 which may be located anywhere in the system, e.g., in or coupled with handpiece 12, coupled with the irrigation tubing 34 and/or aspiration tubing 46, etc. As shown in FIG. 1, AVS 23 is coupled with the proximal end of handpiece 12. AVS device 23 may comprise a valve and a valve actuator, the actuator operating under control of processor 38. On detection of an occlusion, for example by a lowering of the pressure measured by aspiration sensor 52, processor 38 sets device 23 to close aspiration channel 46a, so there is no fluid connection between the proximal and distal sides of AVS device 23. When processor 38 detects that the occlusion has cleared, the processor sets device 23 to open channel 46a, so that fluid connection between the proximal and distal sides of AVS device 23 returns.

The apparatus illustrated in FIG. 1A may include further elements, which are omitted for clarity of presentation. For example, physician 15 typically performs the procedure using a stereo-microscope or magnifying glasses, neither of which are shown. Physician 15 may use other surgical tools, in addition to probe 12, which are also not shown to maintain clarity and simplicity.

Processor 38 may receive user-based commands via a system user interface 40, which may include, but is not limited to, setting and/or adjusting a vibration mode and/or a frequency of piezoelectric actuator 22, setting and/or adjusting a stroke amplitude of needle 16, and setting and/or adjusting an irrigation flow rate and an aspiration flow rate of irrigation pump 24 and aspiration pump 26.

Processor 38 may present setting and parameter information of the phacoemulsification procedure on a display 36. In an example, user interface 40 and display 36 may be one and the same, such as a touch screen graphical user interface.

Processor 38 uses the signals from pressure sensors 52, 56, and 58 to make indirect measurements of the flow rates in the aspiration channel and in the irrigation channel, and so provide indications to control the flow in the aspiration line and in the irrigation line, typically in one or more feedback loops. In order for the measurements and the feedback to operate correctly, prior to physician 15 performing the procedure illustrated in FIG. 1A, probe 12 and its attached needle-sleeve combination 13 are calibrated.

As is stated above, and as is illustrated in FIG. 1A, one of a multiplicity of needle-sleeve combinations 13 is attached to probe 12. Because of the differing dimensions of the needles and sleeves of the different combinations, examples of the present disclosure provide a respective calibration of the needle and of the sleeve for each combination 13 coupled with probe 12.

During a procedure, processor 38 chooses the needle calibration and the sleeve calibration to be used according to the combination coupled with the probe, and the combination being used may be identified by physician 15 to the processor with user interface 40. However, the identification may be incorrect, the physician may not provide an identification, or the combination may be changed during a procedure without an identification of the new combination being provided to the processor.

Examples of the present disclosure provide processor 38 with an independent method for determining the diameter of the needle of the combination being used, and another independent method for determining the diameter of the sleeve being used.

### Needle Diameter

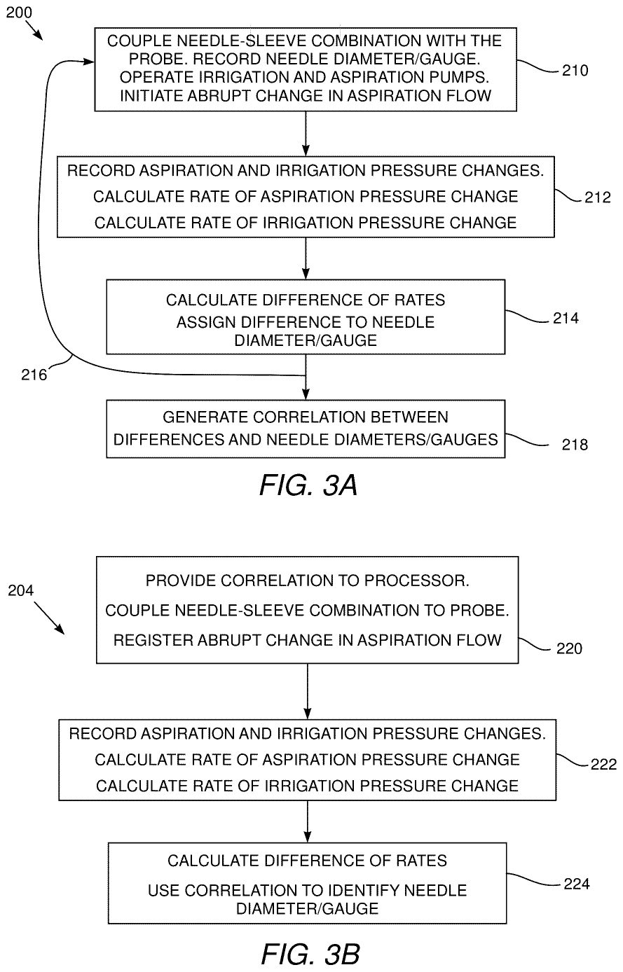

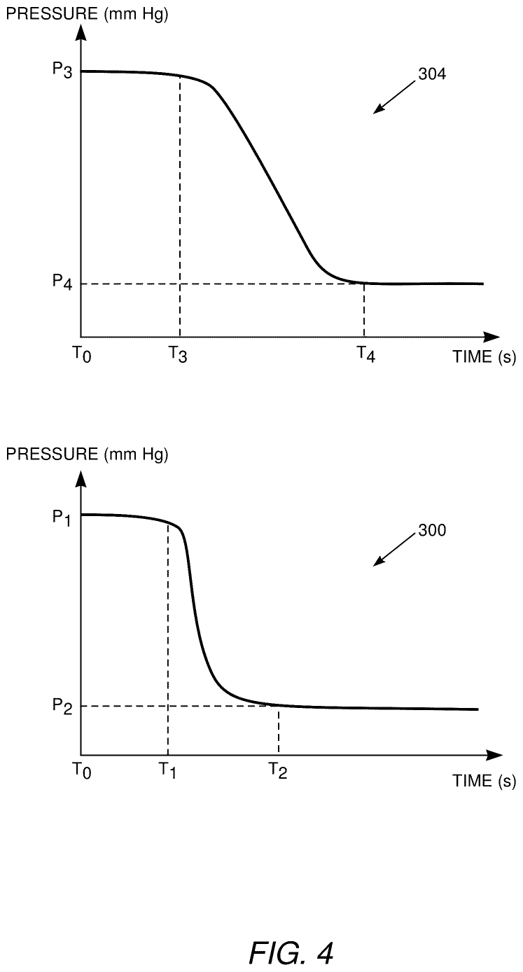

The method for determining the diameter of the needle is described below with reference to the flowcharts of FIGS. 3A and 3B and the graphs of FIG. 4. The method uses the property that in response to an abrupt change of pressure in aspiration line 46b of apparatus 10, the pressure change disperses, i.e., spreads out in time, according to the dimensions, i.e., the gauge or size, of the needle attached to the handpiece.

FIG. 3A is a flowchart 200 of steps for generating a calibration for the needle of the needle-sleeve combination, and FIG. 4 shows schematic graphs illustrating some of the steps, according to an example of the present disclosure.

In an initial step 210, a selected needle-sleeve combination 13, herein assumed to be combination 13A, is coupled with probe 12 by a probe user, and the probe is coupled with the aspiration pump and the irrigation pump, generally as illustrated in FIG. 1A. The probe user provides processor 38 with the size, i.e., the diameter or gauge, of needle 16A.

The distal tip of combination 13A is placed in a liquid such as a balanced salt solution (e.g., in a test chamber or in a fluid filled container), so that there is fluid communication between irrigation line 34b and aspiration line 46b. The placement of the distal tip may be similar to that performed when a probe and coupled needle-sleeve combination are primed prior to being used in a procedure.

Once there is fluid communication between the irrigation and aspiration lines, and their respective pumps are running, processor 38 begins registering signals from aspiration pressure sensor 52 and irrigation pressure sensor 56. While the pumps are running the aspiration flow is abruptly changed. In one example, the abrupt change may be implemented by the probe user occluding the distal tip of needle 16A while maintaining the fluid communication between the irrigation and aspiration lines, but any other convenient method for changing the aspiration flow abruptly may be used. In one example, the change in flow rate is approximately 20 mmHg/1 ms.

In a calibration recordation step 212, processor 38 records the signals, and the times of the signals, of aspiration pressure sensor 52 and irrigation pressure sensor 56. FIG. 4 schematically illustrates an aspiration pressure profile 300, i.e., a pressure vs. time graph 300, for the aspiration pressure sensor, and an irrigation pressure profile 304, i.e., a pressure vs. time graph 304 for the irrigation pressure sensor. In both graphs the start time T₀ is the time when the abrupt change is implemented in step 210. It will be understood that processor 38 converts and stores the signals from sensors 52 and 56 to respective pressure profiles in the form of respective sets of ordered pairs of pressure P and time T, so that a first set {(P, T}}₁ corresponds to pressure profile 300, and a second set {(P, T}}₂ corresponds to pressure profile 304.

As the graphs illustrate, the pressure change as measured by both sensors is not a step function, as is generated by the abrupt change implemented in step 210. Rather the pressure change is dispersed, i.e., the pressure change is spread out over time, because of the narrow dimensions of combination 13A. Examples of the present disclosure quantify the dispersion by assuming that, for each sensor, the pressure measured by the signals from the aspiration sensor and irrigation sensor can be divided into three consecutive periods: a first period wherein the pressure is approximately constant; a second period wherein the pressure changes; and a third period wherein the pressure is approximately constant.

Thus, as illustrated for graph 300, the first period is from T₀ to T₁, the second period is from T₁ to T₂, and the third period is beyond T₂. The pressure is approximately constant for the first period at P₁, decreases from P₁ to P₂ in the second period, and is approximately constant at P₂ for the third period.

For graph 304 the first period is from T₀ to T₃, the second period is from T₃ to T₄, and the third period is beyond T₄. The pressure is approximately constant for the first period at P₃, decreases from P₃ to P₄ in the second period, and is approximately constant at P₄ for the third period.

Processor 38 finds times T₁ and T₃ by finding the time at which the pressure changes by more than a preset amount, compared to the value recorded at time T₀. In one example the preset amount is 10% of the pressure at To. Processor 38 finds times T₂ and T₄ by finding the time at which the incremental pressure change is approximately zero, so that the pressure from times T₂ and T₄ is approximately constant.

The processor records the pressures P₁, P₂, P₃, and P₄ for respective times T₁, T₂, T₃, and T₄, and then uses the recorded pressures and times to find the rate of change of the aspiration pressure, and the rate of change of the irrigation pressure, according to equations (1) and (2):

$${R}_{asp} = \frac{{P}_{2} - {P}_{1}}{{T}_{2} - {T}_{1}} \qquad ( 1 )$$

where Rₐₛₚ is the rate of change of the aspiration pressure.

$${R}_{irr} = \frac{{P}_{4} - {P}_{3}}{{T}_{4} - {T}_{3}} \qquad ( 2 )$$

where Rᵢᵣᵣ is the rate of change of the irrigation pressure.

In an assignment step 214 the processor calculates the difference of the two rates of change, and assigns the difference as an identifier for the needle selected in step 210, according to equation (3):

$${I}_{N} = {R}_{asp} - {R}_{irr} \qquad ( 3 )$$

where I_{N} is the identifier for a needle 16, and N is a numerical index for the needle.

As shown by an arrow 216, the steps 210, 212, and 214 are iterated for different needles 16, and in each iteration the processor calculates an identifier I_{N} for the needle.

In a correlation step 218, after implementing the iterations described above, processor 38 generates and stores a correlation between the identifiers and the needle diameters, i.e., from the correlation, the processor is able to, for a given identifier, determine the needle diameter in the combination being used.

FIG. 3B is a flowchart 204 of steps for finding the diameter of the needle of the needle-sleeve combination being used in a procedure, according to an example of the present disclosure.

In an initial procedure step 220, the processor accesses the correlation stored in flowchart 200. In the initial procedure step, physician 15 selects a needle-sleeve combination 13 and couples the combination with probe 12. The system is primed, and then physician 15 introduces the distal tip of the combination to eye 20 to begin the procedure. During the procedure the aspiration flow rate abruptly changes, for example by the physician altering the flow. Alternatively, the abrupt change in the aspiration flow occurs on operation of AVS device 23.

A procedure recordation step 222 is substantially the same as calibration recordation step 212, except that the processor assumes that time T₀ is the time registered when the abrupt change in the aspiration flow implemented in step 220 occurs. Thus, in step 222 processor 38 records values of P₁, P₂, P₃, and P₄ for respective times T₁, T₂, T₃, and T₄, and from the recorded values calculates values of Rₐₛₚ and Rᵢᵣᵣ according to equations (1) and (2).

In a final step 224 of the flowchart, the processor calculates the difference between Rₐₛₚ and Rᵢᵣᵣ according to equation (3). The calculated difference is an identifier of the needle of the needle-sleeve combination being used in the procedure, and the processor uses the correlation stored in step 218 to find the identity of the needle being used, and consequently the diameter of the needle.

Having the correct value of the needle diameter/gauge in the procedure enables the processor to operate apparatus 10 correctly.

The above provides a description of how the processor may independently determine the needle diameter. The following description explains how the processor may independently determine the sleeve diameter.

### Sleeve Diameter

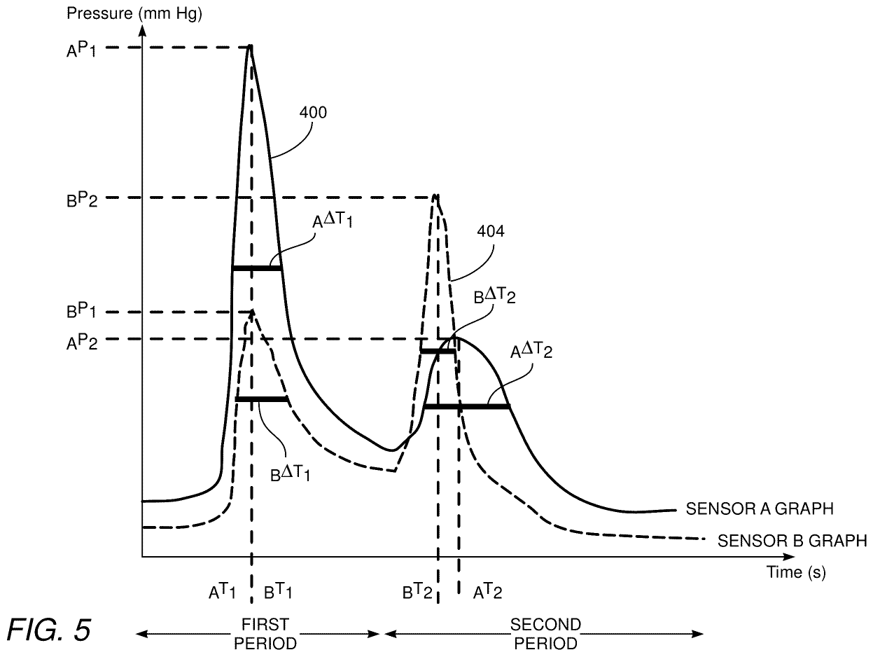

To determine the sleeve size, i.e., the sleeve diameter, processor 38 uses characteristics of the values provided by irrigation pressure sensor A and irrigation pressure sensor B (FIG. 2), and these are described as follows with reference to FIG. 5.

FIG. 5 shows schematic graphs of pressure vs. time for irrigation pressure sensor A and irrigation pressure sensor B, according to an example of the present disclosure. Graphs of FIG. 5 are produced in an experimental setup of handpiece 12 wherein irrigation fluid is pumped through irrigation line 34b, and similar graphs may also be produced during a procedure performed using the handpiece.

A graph 400 is for sensor A, a graph 404 is for sensor B, and the graphs illustrate the change in pressure with time when there is an abrupt change of pressure in irrigation line 34b that causes the pressures to peak. As is illustrated in the figure, the graphs are determined over two time periods, a first time period and a second time period. In each time period, processor 38 registers characteristics of the graphs, the characteristics comprising a peak pressure value, a time at the peak pressure, and a dispersion in time of the pressure about the time of peak pressure.

The dispersion in time relates to the phenomenon wherein different frequency components of a pulse travel at different velocities as they propagate through a medium. This causes the pulse to spread out (broaden) over time and distance, potentially altering its shape and characteristics.

The dispersion in time is herein assumed to be a time difference that may be measured by any convenient method, and in one example the dispersion in time is the time difference between pressures less than the peak by a preset amount, for example 20% of the peak pressure.

Table I gives characteristic identifiers for the first time period, and Table II gives characteristic identifiers for the second time period. The characteristic identifiers are used in the graphs.

TABLE I

| | Sensor A | Sensor B |
|---|---|---|
| Peak Pressure | _{A}P₁ | _{B}P₁ |
| Peak Time | _{A}T₁ | _{B}T₁ |
| Peak Dispersion | _{A}ΔT₁ | _{B}ΔT₁ |

TABLE II

| | Sensor A | Sensor B |
|---|---|---|
| Peak Pressure | _{A}P₂ | _{B}P₂ |
| Peak Time | _{A}T₂ | _{B}T₂ |
| Peak Dispersion | _{A}ΔT₂ | _{B}ΔT₂ |

In Table I (the first time period) the graph peaks are caused by an abrupt change of pressure initiated at a point proximal to handpiece 12. In the experimental setup the proximal change may be implemented by an operator of the setup changing the flow rate of irrigation pump 24. The graphs for the first time period illustrate that for proximal pressure change initiations, the peak times are approximately the same, the peak dispersions are approximately the same, and that the peak pressure for sensor A is greater than the peak pressure for sensor B. Thus, for proximal initiations, the relations of expression (4) are valid:

$$\begin{matrix}{}_{A} {T}_{1} \approx {}_{B} {T}_{1} \\ {}_{A} Δ {T}_{1} \approx {}_{B} Δ {T}_{1} \\ {}_{A} {P}_{1} > {}_{B} {P}_{1}\end{matrix} \} \qquad ( 4 )$$

Table II is for the second time period, wherein the graph peaks are caused by an abrupt change of pressure initiated distally to the handpiece. In the experimental setup the abrupt change may be generated by the setup operator occluding the annular lumen formed by sleeve 17 at the probe distal tip. The graphs for the second time period illustrate that for distal pressure change initiations, sensor B peak time occurs before sensor A peak time, sensor B peak dispersion is less than sensor A peak dispersion, and sensor B peak pressure is larger than sensor A peak pressure. Thus, for distal initiations, the relations of expression (5) are valid:

$$\begin{matrix}{}_{A} {T}_{2} > {}_{B} {T}_{2} \\ {}_{A} Δ {T}_{2} > {}_{B} Δ {T}_{2} \\ {}_{A} {P}_{2} < {}_{B} {P}_{2}\end{matrix} \} \qquad ( 5 )$$

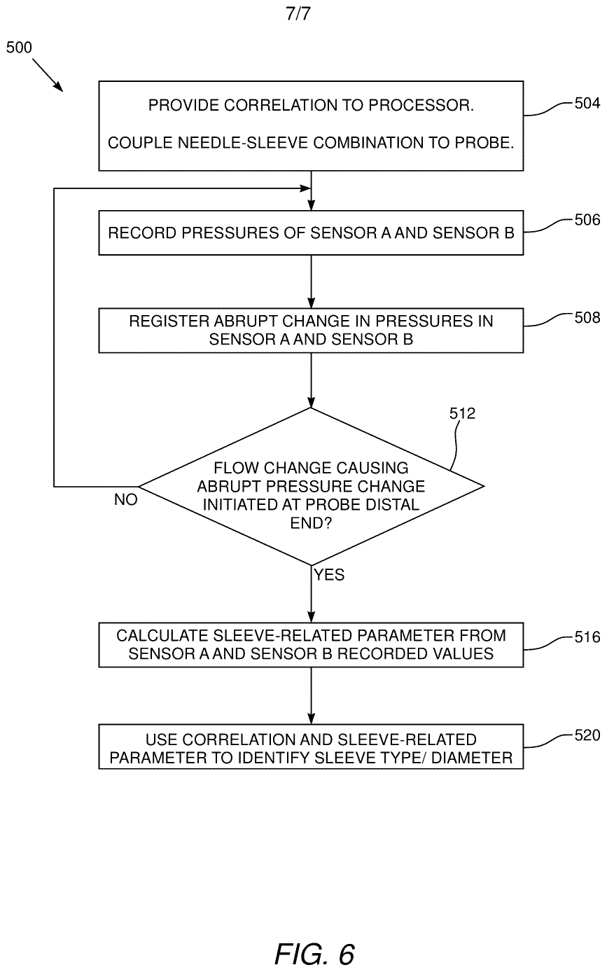

During a procedure, and as described further below in flowchart 500 (FIG. 6), processor 38 differentiates between distally initiated pressure changes and proximally initiated pressure changes. Processor 38 may use any one of the relations of expressions (4) and (5), or a combination of these relations, to identify the type of pressure change. For simplicity, in the following description, the peak pressures are used to identify the pressure change type.

Thus, if the processor uses the pressures of sensors A and B, and finds that the peak pressure of sensor A is greater than the peak pressure of sensor B, then the pressure relation A^{P}1>B^{P}1 of expression (4) is valid, so that the pressure change is proximally initiated. If the peak pressure of sensor A is less than the peak pressure of sensor B, then the pressure relation A^{P}2<B^{P}2 of expression (5) is valid, so that the pressure change is distally initiated.

The relations of expressions (5), for the distally initiated pressure change, may be rewritten as a set (6) of equations:

$$\begin{matrix}{}_{A} {T}_{2} - {}_{A} {T}_{2} = {T}_{AB} \\ {}_{A} Δ {T}_{2} - {}_{B} Δ {T}_{2} = Δ {T}_{A B} \\ {}_{B} {P}_{2} - {}_{A} {P}_{2} = {P}_{B A}\end{matrix} \} \qquad ( 6 )$$

where T_{AB} is the time difference between the peak occurrence for sensor A and sensor B; ΔT_{AB} is the difference between the peak dispersion for sensor A and sensor B; and P_{BA} is the peak pressure difference between sensor B and sensor A. T_{AB}, ΔT_{AB}, and P_{BA} are non-zero positive numbers.

The inventors have found that the values T_{AB}, ΔT_{AB}, and P_{BA} are dependent on the sleeve diameter D_{S} (FIG. 1B) of the needle-sleeve combination 13 being used in the experimental setup, so that T_{AB}, ΔT_{AB}, and P_{BA} are herein termed sleeve-related parameters. In examples of the disclosure, the dependency is used to generate a calibration for the sleeve of the needle-sleeve combination, using one of the sleeve-related parameters. Steps for generating the calibration are substantially the same as those of flowchart 200 (FIG. 3A), mutatis mutandis, wherein the probe user selects different needle-sleeve combinations, provides processor 38 with the sleeve diameter D_{S} for each combination, and the processor records a selected sleeve-related parameter. The processor then stores the calibration as a set of ordered pairs of the selected sleeve-related parameter and the sleeve diameter.

For clarity and simplicity, in the disclosure hereinbelow, except as otherwise noted, the sleeve-related parameter for the calibration is assumed to be P_{BA} (the difference between sensor A peak pressure and sensor B peak pressure), so that the calibration may be written as expression (7):

$$\{ ( {P}_{B A} , {D}_{S} ) \} \qquad ( 7 )$$

Those having ordinary skill in the art will be able to adapt the disclosure, mutatis mutandis, for cases where the sleeve-related parameter is other than P_{BA}, and all such adaptations are assumed to be comprised within the scope of the present disclosure.

FIG. 6 is a flowchart 500 of steps for finding the sleeve diameter of the sleeve of the needle-sleeve combination being used in a procedure, according to an example of the present disclosure. The flowchart uses the calibration of expression (7).

In an initial step 504, the processor is provided with a calibration relating the sleeve-related parameter and the sleeve diameter, herein assumed to be expression (7). Physician 15 couples a needle-sleeve combination 13 to handpiece 12, and then begins operating apparatus 10.

During the operation of the apparatus, processor 38 receives the signals generated by sensors A and B, and from the signals, in a recording step 506, records the corresponding pressures and times registered by the sensors.

In a pressure change step 508, the processor records that sensors A and B have registered an abrupt pressure change corresponding to a local peak in the pressure-time relationship. The abrupt pressure change typically occurs when the aspiration flow rate changes abruptly, as is described above with reference to step 220 of flowchart 200.

In a decision step 512, processor 38 analyzes the recorded pressures to identify if the abrupt change has initiated distally to handpiece 12. If the peak pressure of sensor A is greater than the peak pressure of sensor B, the initiation is proximal, and typically occurs because irrigation pump 24 changes its rate of flow. If the peak pressure of sensor A is less than the peak pressure of sensor B, the initiation is distal, and typically occurs because of an action at the distal tip of combination 13.

If the decision in step 512 is negative, i.e., the initiation is proximal, the flowchart returns to recording step 506.

If the decision in step 512 is positive, i.e., the initiation is distal, the flowchart continues to a parameter calculation step 516. In step 516, the processor calculates the sleeve-related parameter corresponding to the sensor A and sensor B values used in decision step 512. Herein these values are the peak pressures registered by the sensors, so the sleeve-related parameter is the difference in peak pressures of the two sensors.

In a final step 520, the processor uses sleeve-related parameter and the stored calibration to identify the sleeve type/sleeve diameter of the needle-sleeve combination being used.

It will be understood that the sleeve diameter found by flowchart 500 is independent of any input from physician 15, so that even in the cases where there is no input regarding the diameter from the physician, or there is an error in the input, processor 38 is able to operate correctly.

### EXAMPLES

Example 1. Apparatus (10) for determining a size of a needle (16), comprising: a phacoemulsification probe (12) having a distal tip, the probe comprising: an aspiration channel (46a) configured to transfer aspiration fluid from the distal tip and having a first pressure sensor (52) coupled with the aspiration channel; and an irrigation channel (34a) configured to transfer irrigation fluid to the distal tip and having a second pressure sensor (56) coupled with the irrigation channel; a needle-sleeve combination (13), comprising a sleeve (17) coaxially surrounding at least a portion of the needle, configured to couple with the distal tip of the probe; and a processor (38), configured to: acquire from the first pressure sensor a first pressure profile of the aspiration fluid passing the first pressure sensor, acquire from the second pressure sensor a second pressure profile of the irrigation fluid passing the second pressure sensor, formulate a difference between the first pressure profile and the second pressure profile, and determine the size of the needle of the needle-sleeve combination in response to the difference.

Example 2. The apparatus according to example 1, wherein the needle comprises a lumen coupled with the aspiration channel, and wherein the sleeve is coupled with the irrigation channel.

Example 3. The apparatus according to example 1, wherein the processor is configured to compute an aspiration rate of change of aspiration fluid pressure from the first pressure profile, and to compute an irrigation rate of change of irrigation fluid pressure from the second pressure profile, and to formulate the difference as the difference between the aspiration rate of change of aspiration fluid pressure and the irrigation rate of change of irrigation fluid pressure.

Example 4. The apparatus according to example 1, wherein the processor is configured to determine the size of the needle of the needle-sleeve combination in response to the difference and a predetermined correlation between the size of the needle and the difference.

Example 5. The apparatus according to example 1, and comprising a further needle-sleeve combination, comprising a further sleeve coaxially surrounding at least a portion of a further needle, configured to attach to the distal tip of the probe, wherein the processor is configured to identify one of the needle-sleeve combination and the further needle-sleeve combination attached to the distal tip in response to the difference.

Example 6. The apparatus according to example 1, wherein the processor is configured to acquire the first pressure profile and the second pressure profile in response to an abrupt change in a flow rate of the aspiration fluid.

Example 7. The apparatus according to example 1, wherein the processor is configured to acquire the first pressure profile and the second pressure profile in response to closing the aspiration channel.

Example 8. The apparatus according to example 1, wherein the needle comprises an internal lumen, and wherein the size of the needle comprises a diameter of the internal lumen.

Example 9. A method for determining a size of a needle (16), comprising: providing a phacoemulsification probe (12) having a distal tip, the probe comprising: an aspiration channel (46a) configured to transfer aspiration fluid from the distal tip and having a first pressure sensor (52) coupled with the aspiration channel; and an irrigation channel (34a) configured to transfer irrigation fluid to the distal tip and having a second pressure sensor (56) coupled with the irrigation channel; configuring a needle-sleeve combination (13), comprising a sleeve (17) coaxially surrounding at least a portion of the needle, to attach to the distal tip of the probe; acquiring from the first pressure sensor a first pressure profile of the aspiration fluid passing the first pressure sensor; acquiring from the second pressure sensor a second pressure profile of the irrigation fluid passing the second pressure sensor; formulating a difference between the first pressure profile and the second pressure profile, and determining the size of the needle of the combination in response to the difference.

Example 10. The method according to example 9, wherein the needle comprises a lumen coupled with the aspiration channel, and wherein the sleeve is coupled with the irrigation channel.

Example 11. The method according to example 9, further comprising computing an aspiration rate of change of aspiration fluid pressure from the first pressure profile, and computing an irrigation rate of change of irrigation fluid pressure from the second pressure profile, and formulating the difference as the difference between the aspiration rate of change of aspiration fluid pressure and the irrigation rate of change of irrigation fluid pressure.

Example 12. The method according to example 9, further comprising determining the size of the needle of the needle-sleeve combination in response to the difference and a predetermined correlation between the size of the needle and the difference.

Example 13. The method according to example 9, and comprising providing a further needle-sleeve combination, comprising a further sleeve coaxially surrounding at least a portion of a further needle, configured to attach to the distal tip of the probe, the method further comprising identifying one of the needle-sleeve combination and the further needle-sleeve combination coupled with the distal tip in response to the difference.

Example 14. The method according to example 9, further comprising acquiring the first pressure profile and the second pressure profile in response to an abrupt change in a flow rate of the aspiration fluid.

Example 15. The method according to example 9, further comprising acquiring the first pressure profile and the second pressure profile in response to closing the aspiration channel.

Example 16. The method according to example 9, wherein the needle comprises an internal lumen, and wherein the size of the needle comprises a diameter of the internal lumen.

Example 17. A method, comprising: providing a phacoemulsification probe (12) having a distal tip, the probe comprising: an aspiration channel (46a) configured to transfer aspiration fluid from the distal tip and having a first pressure sensor (52) coupled with the aspiration channel; and an irrigation channel (34a) configured to transfer irrigation fluid to the distal tip and having a second pressure sensor (56) coupled with the irrigation channel; for each of a plurality of iterations: attaching a needle-sleeve combination (13) comprising a sleeve (17) coaxially surrounding at least a portion of a needle (16), to the distal tip of the probe; recording a size of the needle; acquiring from the first pressure sensor a first pressure profile of the aspiration fluid passing the first pressure sensor; acquiring from the second pressure sensor a second pressure profile of the irrigation fluid passing the second pressure sensor; formulating a difference between the first pressure profile and the second pressure profile; and generating a correspondence between the size of the needle of the combination and the difference for the plurality of iterations.

Example 18. Apparatus (10), comprising: a phacoemulsification probe (12) having a distal tip, the probe comprising: an irrigation channel (34a) configured to transfer irrigation fluid to the distal tip and having a first pressure sensor (56) coupled with the irrigation channel and a second pressure sensor (58) coupled, distally from the first pressure sensor, with the irrigation channel; a needle-sleeve combination (13), comprising a sleeve (17) coaxially surrounding at least a portion of a needle (16), configured to couple with the distal tip of the probe; and a processor (38), configured to: acquire from the first pressure sensor a first reading in response to the irrigation fluid passing the first pressure sensor, acquire from the second pressure sensor a second reading in response to the irrigation fluid passing the second pressure sensor, formulate a difference between the first pressure reading and the second pressure reading, and determine a size of the sleeve of the needle-sleeve combination in response to the difference.

19. The apparatus according to example 18, further comprising formulating the difference in response to the processor determining from the first reading and the second reading that there has been an abrupt change of pressure in the irrigation channel.

Example 20. The apparatus according to example 19, wherein the processor is configured to identify that the abrupt change of pressure initiates distally to the probe.

Example 21. The apparatus according to example 18, wherein the first reading and the second reading respectively comprise a first pressure of a first local peak pressure and a second pressure of a second local peak pressure.

Example 22. The apparatus according to example 18, wherein the first reading and the second reading respectively comprise a first time of a first local peak pressure and a second time of a second local peak pressure.

Example 23. The apparatus according to example 18, wherein the first reading and the second reading respectively comprise a first time difference of pressures related to a first local peak pressure and a second time difference of pressures related to a second local peak pressure.

Example 24. The apparatus according to example 18, wherein the size of the sleeve comprises a diameter of the sleeve.

Example 25. The apparatus according to example 24, wherein the sleeve and the needle are configured to form an annular lumen therebetween, and wherein the diameter of the sleeve comprises an effective diameter of the annular lumen.

Example 26. A method, comprising: providing a phacoemulsification probe (12) having a distal tip, the probe comprising: an irrigation channel (34a) configured to transfer irrigation fluid to the distal tip and having a first pressure sensor (56) coupled with the irrigation channel and a second pressure sensor (58) coupled, distally from the first pressure sensor, with the irrigation channel; forming a needle-sleeve combination (13), comprising a sleeve (17) coaxially surrounding at least a portion of a needle (16); coupling the needle-sleeve combination with the distal tip of the probe; acquiring from the first pressure sensor a first reading in response to the irrigation fluid passing the first pressure sensor; acquiring from the second pressure sensor a second reading in response to the irrigation fluid passing the second pressure sensor; formulating a difference between the first reading and the second reading; and determining a size of the sleeve of the needle-sleeve combination in response to the difference.

Example 27. The method according to example 26, further comprising formulating the difference in response to determining from the first reading and the second reading that there has been an abrupt change of pressure in the irrigation channel.

Example 28. The method according to example 27, further comprising identifying that the abrupt change of pressure initiated distally to the probe.

Example 29. The method according to example 26, wherein the first reading and the second reading respectively comprise a first pressure of a first local peak pressure and a second pressure of a second local peak pressure.

Example 30. The method according to example 26, wherein the first reading and the second reading respectively comprise a first time of a first local peak pressure and a second time of a second local peak pressure.

Example 31. The method according to example 26, wherein the first reading and the second reading respectively comprise a first time difference of pressures related to a first local peak pressure and a second time difference of pressures related to a second local peak pressure.

Example 32. The method according to example 26, wherein the size of the sleeve comprises a diameter of the sleeve.

Example 33. The method according to example 32, wherein the sleeve and the needle form an annular lumen therebetween, and wherein the diameter of the sleeve comprises an effective diameter of the annular lumen.

The examples described above are cited by way of example, and the present disclosure is not limited by what has been particularly shown and described hereinabove. Rather, the scope of the disclosure includes both combinations and sub-combinations of the various features described hereinabove, as well as variations and modifications thereof which would occur to persons skilled in the art upon reading the foregoing description and which are not disclosed in the prior art.

1. Apparatus for determining a size of a needle, comprising:
a phacoemulsification probe having a distal tip, the probe comprising:
an aspiration channel configured to transfer aspiration fluid from the distal tip and having a first pressure sensor coupled with the aspiration channel; and
an irrigation channel configured to transfer irrigation fluid to the distal tip and having a second pressure sensor coupled with the irrigation channel;
a needle-sleeve combination, comprising a sleeve coaxially surrounding at least a portion of the needle, configured to couple with the distal tip of the probe; and
a processor, configured to:
acquire from the first pressure sensor a first pressure profile of the aspiration fluid passing the first pressure sensor,
acquire from the second pressure sensor a second pressure profile of the irrigation fluid passing the second pressure sensor,
formulate a difference between the first pressure profile and the second pressure profile, and
determine the size of the needle of the needle-sleeve combination in response to the difference.

2. The apparatus according to claim 1, wherein the needle comprises a lumen coupled with the aspiration channel, and wherein the sleeve is coupled with the irrigation channel.

3. The apparatus according to claim 1, wherein the processor is configured to compute an aspiration rate of change of aspiration fluid pressure from the first pressure profile, and to compute an irrigation rate of change of irrigation fluid pressure from the second pressure profile, and to formulate the difference as the difference between the aspiration rate of change of aspiration fluid pressure and the irrigation rate of change of irrigation fluid pressure.

4. The apparatus according to claim 1, wherein the processor is configured to determine the size of the needle of the needle-sleeve combination in response to the difference and a predetermined correlation between the size of the needle and the difference.

5. The apparatus according to claim 1, and comprising a further needle-sleeve combination, comprising a further sleeve coaxially surrounding at least a portion of a further needle, configured to attach to the distal tip of the probe, wherein the processor is configured to identify one of the needle-sleeve combination and the further needle-sleeve combination attached to the distal tip in response to the difference.

6. The apparatus according to claim 1, wherein the processor is configured to acquire the first pressure profile and the second pressure profile in response to an abrupt change in a flow rate of the aspiration fluid.

7. The apparatus according to claim 1, wherein the processor is configured to acquire the first pressure profile and the second pressure profile in response to closing the aspiration channel.

8. The apparatus according to claim 1, wherein the needle comprises an internal lumen, and wherein the size of the needle comprises a diameter of the internal lumen.

9. A method for determining a size of a needle, comprising:
providing a phacoemulsification probe having a distal tip, the probe comprising:
an aspiration channel configured to transfer aspiration fluid from the distal tip and having a first pressure sensor coupled with the aspiration channel; and
an irrigation channel configured to transfer irrigation fluid to the distal tip and having a second pressure sensor coupled with the irrigation channel;
configuring a needle-sleeve combination, comprising a sleeve coaxially surrounding at least a portion of the needle, to attach to the distal tip of the probe;
acquiring from the first pressure sensor a first pressure profile of the aspiration fluid passing the first pressure sensor;
acquiring from the second pressure sensor a second pressure profile of the irrigation fluid passing the second pressure sensor;
formulating a difference between the first pressure profile and the second pressure profile, and
determining the size of the needle of the combination in response to the difference.

10. The method according to claim 9, wherein the needle comprises a lumen coupled with the aspiration channel, and wherein the sleeve is coupled with the irrigation channel.

11. The method according to claim 9, further comprising computing an aspiration rate of change of aspiration fluid pressure from the first pressure profile, and computing an irrigation rate of change of irrigation fluid pressure from the second pressure profile, and formulating the difference as the difference between the aspiration rate of change of aspiration fluid pressure and the irrigation rate of change of irrigation fluid pressure.

12. The method according to claim 9, further comprising determining the size of the needle of the needle-sleeve combination in response to the difference and a predetermined correlation between the size of the needle and the difference.

13. The method according to claim 9, and comprising providing a further needle-sleeve combination, comprising a further sleeve coaxially surrounding at least a portion of a further needle, configured to attach to the distal tip of the probe, the method further comprising identifying one of the needle-sleeve combination and the further needle-sleeve combination coupled with the distal tip in response to the difference.

14. The method according to claim 9, further comprising acquiring the first pressure profile and the second pressure profile in response to an abrupt change in a flow rate of the aspiration fluid.

15. The method according to claim 9, further comprising acquiring the first pressure profile and the second pressure profile in response to closing the aspiration channel.

16. The method according to claim 9, wherein the needle comprises an internal lumen, and wherein the size of the needle comprises a diameter of the internal lumen.

17. A method, comprising:
providing a phacoemulsification probe having a distal tip, the probe comprising:
an aspiration channel configured to transfer aspiration fluid from the distal tip and having a first pressure sensor coupled with the aspiration channel; and
an irrigation channel configured to transfer irrigation fluid to the distal tip and having a second pressure sensor coupled with the irrigation channel;
for each of a plurality of iterations:
attaching a needle-sleeve combination comprising a sleeve coaxially surrounding at least a portion of a needle, to the distal tip of the probe;
recording a size of the needle;
acquiring from the first pressure sensor a first pressure profile of the aspiration fluid passing the first pressure sensor;
acquiring from the second pressure sensor a second pressure profile of the irrigation fluid passing the second pressure sensor;
formulating a difference between the first pressure profile and the second pressure profile; and
generating a correspondence between the size of the needle of the combination and the difference for the plurality of iterations.

18. Apparatus, comprising:
a phacoemulsification probe having a distal tip, the probe comprising:
an irrigation channel configured to transfer irrigation fluid to the distal tip and having a first pressure sensor coupled with the irrigation channel and a second pressure sensor coupled, distally from the first pressure sensor, with the irrigation channel;
a needle-sleeve combination, comprising a sleeve coaxially surrounding at least a portion of a needle, configured to couple with the distal tip of the probe; and
a processor, configured to:
acquire from the first pressure sensor a first reading in response to the irrigation fluid passing the first pressure sensor,
acquire from the second pressure sensor a second reading in response to the irrigation fluid passing the second pressure sensor,
formulate a difference between the first pressure reading and the second pressure reading, and
determine a size of the sleeve of the needle-sleeve combination in response to the difference.

19. The apparatus according to claim 18, further comprising formulating the difference in response to the processor determining from the first reading and the second reading that there has been an abrupt change of pressure in the irrigation channel.

20. The apparatus according to claim 19, wherein the processor is configured to identify that the abrupt change of pressure initiates distally to the probe.

21. The apparatus according to claim 18, wherein the first reading and the second reading respectively comprise a first pressure of a first local peak pressure and a second pressure of a second local peak pressure.

22. The apparatus according to claim 18, wherein the first reading and the second reading respectively comprise a first time of a first local peak pressure and a second time of a second local peak pressure.

23. The apparatus according to claim 18, wherein the first reading and the second reading respectively comprise a first time difference of pressures related to a first local peak pressure and a second time difference of pressures related to a second local peak pressure.

24. The apparatus according to claim 18, wherein the size of the sleeve comprises a diameter of the sleeve.

25. The apparatus according to claim 24, wherein the sleeve and the needle are configured to form an annular lumen therebetween, and wherein the diameter of the sleeve comprises an effective diameter of the annular lumen.

26. A method, comprising:
providing a phacoemulsification probe having a distal tip, the probe comprising:
an irrigation channel configured to transfer irrigation fluid to the distal tip and having a first pressure sensor coupled with the irrigation channel and a second pressure sensor coupled, distally from the first pressure sensor, with the irrigation channel;
forming a needle-sleeve combination, comprising a sleeve coaxially surrounding at least a portion of a needle;
coupling the needle-sleeve combination with the distal tip of the probe;
acquiring from the first pressure sensor a first reading in response to the irrigation fluid passing the first pressure sensor;
acquiring from the second pressure sensor a second reading in response to the irrigation fluid passing the second pressure sensor;
formulating a difference between the first reading and the second reading; and
determining a size of the sleeve of the needle-sleeve combination in response to the difference.

27. The method according to claim 26, further comprising formulating the difference in response to determining from the first reading and the second reading that there has been an abrupt change of pressure in the irrigation channel.

28. The method according to claim 27, further comprising identifying that the abrupt change of pressure initiated distally to the probe.

29. The method according to claim 26, wherein the first reading and the second reading respectively comprise a first pressure of a first local peak pressure and a second pressure of a second local peak pressure.

30. The method according to claim 26, wherein the first reading and the second reading respectively comprise a first time of a first local peak pressure and a second time of a second local peak pressure.

31. The method according to claim 26, wherein the first reading and the second reading respectively comprise a first time difference of pressures related to a first local peak pressure and a second time difference of pressures related to a second local peak pressure.

32. The method according to claim 26, wherein the size of the sleeve comprises a diameter of the sleeve.

33. The method according to claim 32, wherein the sleeve and the needle form an annular lumen therebetween, and wherein the diameter of the sleeve comprises an effective diameter of the annular lumen.
